(19) United States
(12) Patent Application Publication
(10) Pub. No.: US 2025/0102640 A1
(43) Pub. Date: Mar. 27, 2025

(54) LASER DETECTION METHOD AND DEVICE

(71) Applicant: SUTENG INNOVATION TECHNOLOGY CO., LTD., Shenzhen (CN)

(72) Inventor: Yan ZHAO, Shenzhen (CN)

(73) Assignee: SUTENG INNOVATION TECHNOLOGY CO., LTD., Shenzhen (CN)

(21) Appl. No.: 18/806,665

(22) Filed: Aug. 15, 2024

(30) Foreign Application Priority Data
Sep. 25, 2023 (CN) 202311243411.9

(51) Int. Cl. G01S 7/484

(52) U.S. Cl. CPC G01S 7/484

(57) ABSTRACT

This application provides a laser detection method and device, applied to LiDAR. The LiDAR includes a first emitting unit, and the laser detection method includes: obtaining a random variable; determining a plurality of first emission times according to the random variable; and controlling the first emitting unit to emit a laser signal at the plurality of first emission times.

### CROSS-REFERENCE TO RELATED APPLICATION

The present application claims the benefit of priority to Chinese Patent Application No. 202311243411.9, filed on Sep. 25, 2023, which is hereby incorporated by reference in its entirety.

### TECHNICAL FIELD

This application relates to the field of laser detection technology, and particularly relates to a laser detection method and device.

### TECHNICAL BACKGROUND

Laser detection devices are systems that use laser beams to detect features such as the position and speed of a target. The working principle is to first emit a detection laser at the target, then compare the received echo signal reflected from the target with the emitted signal, and after appropriate processing, obtain relevant information about the target, such as distance, azimuth, altitude, speed, attitude, and even shape.

LiDAR is a mainstream radar sensor that primarily obtains point cloud data through the echoes of emitted laser beams, thereby detecting objects in the environment. However, if multiple LiDARs conduct detection simultaneously, they are likely to interfere with each other, leading to affected point cloud data and reduced detection accuracy.

### SUMMARY

Embodiments of this application provide a laser detection method that can enhance the anti-interference effect of LiDAR, improving detection accuracy.

In a first aspect, embodiments of this application provide a laser detection method, applied to a LiDAR, where the LiDAR includes a first emitting unit, the method including:

obtaining a random variable; determining a plurality of first emission times according to the random variable; controlling the first emitting unit to emit a laser signal at the plurality of first emission times.

In an embodiment, the LiDAR further includes a pseudo-random number generator, the random variable includes a seed value and a step size, and the determining the plurality of first emission times according to the random variable includes:
generating a first delay period set by the pseudo-random number generator according to the seed value and the step size, where the first delay period set includes a plurality of delay periods;
determining the first emission times corresponding to the laser signal according to the plurality of delay periods.

In an embodiment, the plurality of first emission times includes X first emission times, the X first emission times correspond one-to-one to X first receiving times, the X first emission times include an i^{th} first emission time and an i^{th}+1 first emission time, the i^{th} first receiving time in the X first receiving times corresponds to the i^{th} first emission time, 0≤i≤X, and i and X are both integers;
and the determining the first emission times corresponding to the laser signal according to the plurality of delay periods includes:
selecting a first delay period in the plurality of delay periods as a delay period of the i^{th}+1 first emission time relative to the i^{th} first receiving time;
determining the i^{th}+1 first emission time according to the i^{th} first receiving time and the first delay period.

In an embodiment, the LiDAR further includes a true random number generator, and the true random number generator is cascaded with the pseudo-random number generator, and the obtaining a random variable includes:
obtaining the random variable according to the true random number generator.

In an embodiment, the LiDAR further includes a second emitting unit, and the method further includes:
obtaining a second delay period;
determining a plurality of second emission times according to the plurality of first emission times and the second delay period, the plurality of first emission times correspond one-to-one to the plurality of second emission times, and the second delay period is a delay period of a corresponding one of the plurality of second emission times relative to a corresponding one of the plurality of first emission times;
controlling the second emitting unit to emit a laser signal at the plurality of second emission times.

In an embodiment, the obtaining a second delay period includes:
using a difference between a third delay period and a fourth delay period as the second delay period;
where the plurality of first emission times correspond one-to-one to a plurality of third emission times, the plurality of first emission times correspond one-to-one to the plurality of third emission times, the third emission time is a preset emission time for the first emitting unit and the second emitting unit, the third delay period is a delay period of a corresponding one of the plurality of first emission times relative to a corresponding one of the plurality of third emission times, and the fourth delay period is a delay period of a corresponding one of the plurality of second emission times relative to a corresponding one of the plurality of third emission times.

In an embodiment, the LiDAR further includes a first register and a second register, and the method further includes:
configuring the third delay period according to the first register;
configuring the fourth delay period according to the second register.

In an embodiment, the plurality of first emission times includes X first emission times, the plurality of first emission times includes a z^{th} first emission time, z≥1, and z is an integer, and the determining the plurality of first emission times according to the random variable includes:
selecting a fifth delay period in a second delay set, the second delay set includes a plurality of delay periods with different durations;
determining the z^{th} first emission time according to the random variable and the fifth delay period.

In an embodiment, the first emitting unit includes a voltage-controlled delay chain, and the method further includes:
periodically generating a plurality of third delay sets by the voltage-controlled delay chain, the plurality of third delay sets correspond one-to-one to the plurality of first emission times, and the second delay set is a set in the plurality of third delay sets corresponding to the z^{th} first emission time.

In a second aspect, the embodiments of this application provide a laser detection device, including:
an obtaining module, configured to obtain a random variable;
a processing module, configured to determine a plurality of first emission times according to the random variable;
a transceiving module, configured to control the first emitting unit to emit a laser signal at the plurality of first emission times.

In a third aspect, the embodiments of this application provide a laser detection device including a storage, a processor, and a computer program stored in the storage and executable on the processor. The processor implements the steps of the method as described above when executing the computer program.

In a fourth aspect, the embodiments of this application provide a computer-readable storage medium. The computer-readable storage medium stores a computer program, and the computer program, when executed by a processor, implements the steps of the method as described above.

After the chip is activated, the pseudo-random number generator will read the seed value and step size transmitted by the true random number generator, and then generate a series of random values based on this, i.e., the first delay period set. By superimposing the selected delay period on the previous receiving time of the laser signal, the emission time of the current laser signal is obtained, which can minimize the overlap of flight times of different LiDARs, thereby enhancing the anti-interference effect of the LiDAR and improving detection accuracy. Further, the random numbers generated by the true random number generator are not produced by computational or predictable methods but are derived from unpredictable physical processes. This further strengthens the anti-interference effect of LiDAR, improving detection accuracy.

### BRIEF DESCRIPTION OF DRAWINGS

FIG. 1 is a schematic diagram of the sending and receiving times of LiDAR #1 and LiDAR #2 in accordance with some embodiments of this application;

FIG. 2 is a schematic diagram of the laser detection method 100 provided in accordance with some embodiments of this application;

FIG. 3 is a schematic diagram of an exemplary architecture of LiDAR #1 and LiDAR #2 in accordance with some embodiments of this application;

FIG. 4A is a schematic diagram of the sending and receiving times of LiDAR #1 and LiDAR #2 in accordance with some embodiments of this application;

FIG. 4B is another example of the sending and receiving times of LiDAR #1 and LiDAR #2 in accordance with some embodiments of this application;

FIG. 5 is a schematic diagram of an exemplary architecture of the first emitting unit in accordance with some embodiments of this application;

FIG. 6 is a schematic diagram of the laser detection method 200 in accordance with some embodiments of this application;

FIG. 7 is a schematic diagram of the simultaneous scanning times of the left and right channels within a LiDAR in accordance with some embodiments of this application;

FIG. 8A is a schematic diagram of the sampling situation without adding jitter in accordance with some embodiments of this application;

FIG. 8B is a schematic diagram of the sampling situation of the first scan after adding jitter in accordance with some embodiments of this application;

FIG. 8C is a schematic diagram of the sampling situation of the second scan after adding jitter in accordance with some embodiments of this application;

FIG. 8D is a schematic diagram of the combined sampling situation after adding jitter for two scans in accordance with some embodiments of this application;

FIG. 9 is a schematic diagram of a laser detection device in accordance with some embodiments of this application; and

FIG. 10 is another schematic diagram of a laser detection device in accordance with some embodiments of this application.

### DETAILED DESCRIPTION

To make the objectives, technical solutions, and advantages of this application clearer, the following describes the embodiments of this application in further detail with reference to the accompanying drawings.

The “multiple” mentioned in this application refers to two or more. Unless otherwise stated, the “/” means “or,” for example, A/B can mean A or B; “and/or” describes the associative relationship of associated objects, meaning there can be three relationships, for example, A and/or B can mean: A alone, both A and B together, or B alone. To facilitate clear description of this application's technical solutions, the terms “first,” “second,” etc. are used to distinguish similar items or similar functions. The terms “first,” “second,” etc. do not limit quantity or execution order and do not necessarily denote different entities.

For convenience and simplicity of description, the division of the functional units or modules mentioned above is exemplary. The above functions can be assigned to different functional units or modules as needed, the internal structure of the device can be divided into different functional units or modules to complete all or part of the functions described above. The functional units or modules in the embodiments can be integrated into one processing unit, or can exist separately, or can be integrated into one unit. The integrated unit can be implemented in hardware or software. Furthermore, the names of the functional units or modules are just for convenience of mutual distinction. The working process of the units or modules in the system can refer to the corresponding process in the previous method embodiments.

In an embodiment, the laser detection method is executed by a LiDAR using the time-of-flight (ToF) radar.

### Time-of-Flight Technology and ToF Radar.

Time-of-flight technology is a technique for understanding certain properties of ions or media by measuring the time it takes for an object, particle, or wave to travel a certain distance in a fixed medium (the medium/distance/time are all known or measurable). Exemplarily, the distance from the sensor to an object is measured by emitting laser pulses. The laser pulse means multiple collimated light pulses emitted one after another in a short time interval. They are reflected by the object and collected again by the detector. The time required to emit and receive the laser pulse is calculated to get the distance from the sensor to the object.

ToF radar: The laser emits a laser signal to the measured object, which, after reflection, reaches the photodetector, converts the signal, and sends it to the echo signal processing circuit, and obtains an electrical pulse signal sent to the timer to calculate the time of light flight. Since the speed of light is constant, by measuring the total time from the departure to the reception of light, dividing it by two and multiplying by the speed of light, the distance from the radar to the measured object can be calculated.

Pseudo-random number generator and true random number generator.

In an embodiment, a LiDAR includes a pseudo-random number generator and/or, a true random number generator.

The pseudo-random number generator is used to calculate pseudo-random numbers through a series of seed values when the system needs random numbers. Pseudo-random numbers are as close to randomness as possible, there is a “seed value,” pseudo-random numbers are controllable and predictable to some extent.

A true random number generator is a device used to generate random numbers, and its output random numbers are generated based on physical random phenomena or processes that have inherent randomness. Unlike pseudo-random number generators, true random number generators generate random numbers from unpredictable physical processes rather than through computational or predictable methods.

### Sampling Rate of LiDAR.

The sampling rate, also called the sampling speed or sampling frequency, is the number of times collected per second. The sampling rate of LiDAR refers to the number of point clouds obtained by the radar per second, which can be calculated based on the scanning range, angular resolution, and frame rate. The higher the value, the more signal is collected per unit time.

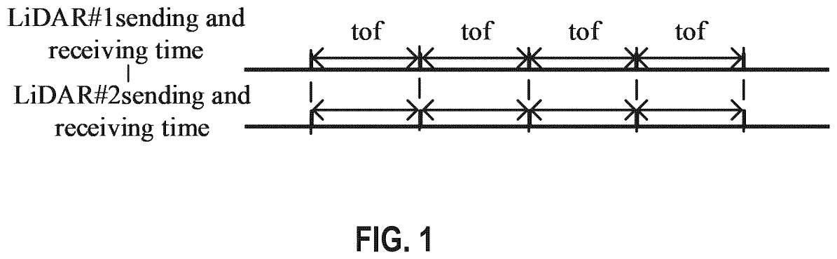

When multiple LiDARs conduct detection at the same time, different LiDARs may interfere with each other, leading to the point cloud data being affected and thus reducing the detection accuracy of the LiDAR. FIG. 1 shows a schematic diagram of the sending and receiving times of LiDAR #1 and LiDAR #2. As shown in FIG. 1, the flight times of LiDAR #1 and LiDAR #2 overlap, or the sending and receiving times of LiDAR #1 and LiDAR #2 overlap. At this time, the returned laser received by LiDAR #1 may not be emitted by this device, resulting in severe mutual interference between different LiDARs.

In an embodiment, encoding and decoding of symbols are used. For ToF LiDAR, to encode the sending and receiving times rather than the laser beam itself. In an embodiment, a coding sequence that includes multiple periods is pre-stored. Each time a laser is emitted, a period from the coding sequence is taken as the emission superposition period for this emission, and the next laser emission is carried out after superimposing the emission superposition period on a fixed emission cycle. Since the sequence is pre-configured by the microprocessor, it is not absolutely random. Therefore, two LiDARs of the same model may still interfere with each other when using the same software program to generate the coding sequence.

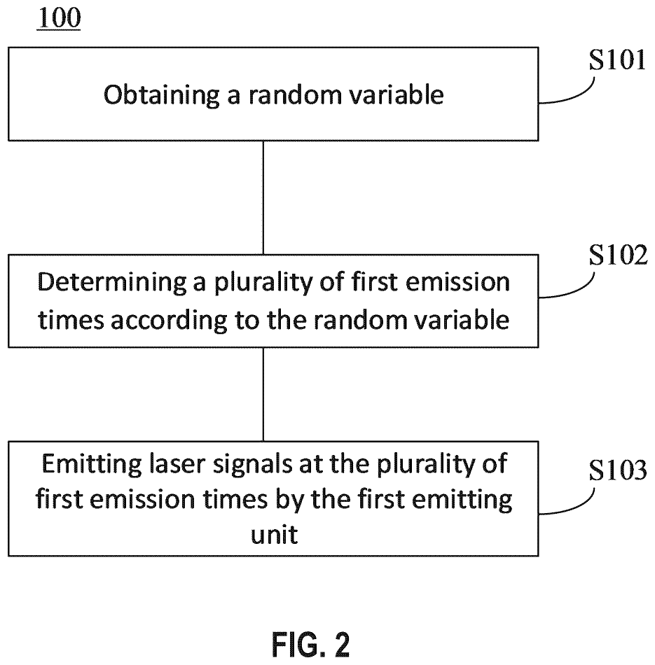

FIG. 2 shows a schematic diagram of the laser detection method 100 provided by an embodiment. This method 100 is applied to LiDAR. The LiDAR includes a first emitting unit, and a true random number generator and a pseudo-random number generator, with the true random number generator cascaded with the pseudo-random number generator.

S101, obtaining a random variable.

The random variable includes a seed value and a step size. Exemplarily, the step size ranges from a minimum of 2 ns to a maximum of 64 ns.

Exemplarily, the random variable is generated by the true random number generator.

S102, determining a plurality of first emission times according to the random variable.

In one embodiment, the plurality of emission times corresponding to the plurality of laser signals emitted is determined based on the random variable.

For example, the LiDAR includes a pseudo-random number generator, the random variable includes a seed value. The first delay period set is generated by the pseudo-random number generator based on the seed value and the step size. The first delay period set includes multiple delay periods. It can be understood that these multiple delay periods are a series of random values generated by the pseudo-random number generator based on the seed value and the step size. For each laser signal emitted by the first emitting unit, the emission time of each laser signal is determined based on the delay period selected from the multiple delay periods. In some embodiments, different delay periods can be randomly selected from the multiple delay periods for each laser signal. For example, by superimposing the selected delay period on the last received laser signal's receiving time, the emission time of this laser signal is obtained.

In an embodiment, the plurality of first emission times includes X first emission times, X first emission times correspond one-to-one to X first receiving times, X first emission times include the i^{th} first emission time and the i^{th}+1 first emission time, the i^{th} first receiving time in the X first receiving times corresponds to the i^{th} first emission time, 0≤i≤X, i and X are both integers. The first delay period is selected from the multiple delay periods as the delay period of the i^{th}+1 first emission time relative to the i^{th} first receiving time; the i^{th}+1 first emission time is determined according to the i^{th} first receiving time and the first delay period.

S103, emitting laser signals at the plurality of first emission times by the first emitting unit.

After the chip is activated, the pseudo-random number generator will read the seed value and step size transmitted from the true random number generator, and then cyclically generate a series of random values based on the seed value and step size, that is, the first delay period set mentioned above. By superimposing the selected delay period (i.e., the first delay period) on the last received laser signal's receiving time, the emission time of this laser signal is obtained, which can minimize the overlap of the flight times of different LiDARs, thereby enhancing the anti-interference effect of the LiDAR and improving detection accuracy.

Further, the random number generated by the true random number generator is derived from unpredictable physical processes rather than calculable or predictable methods. Therefore, even if two LiDARs of the same model (such as LiDAR #1 and LiDAR #2) are activated at the same time, the true random number generators in different LiDARs will generate different seed values and step sizes.

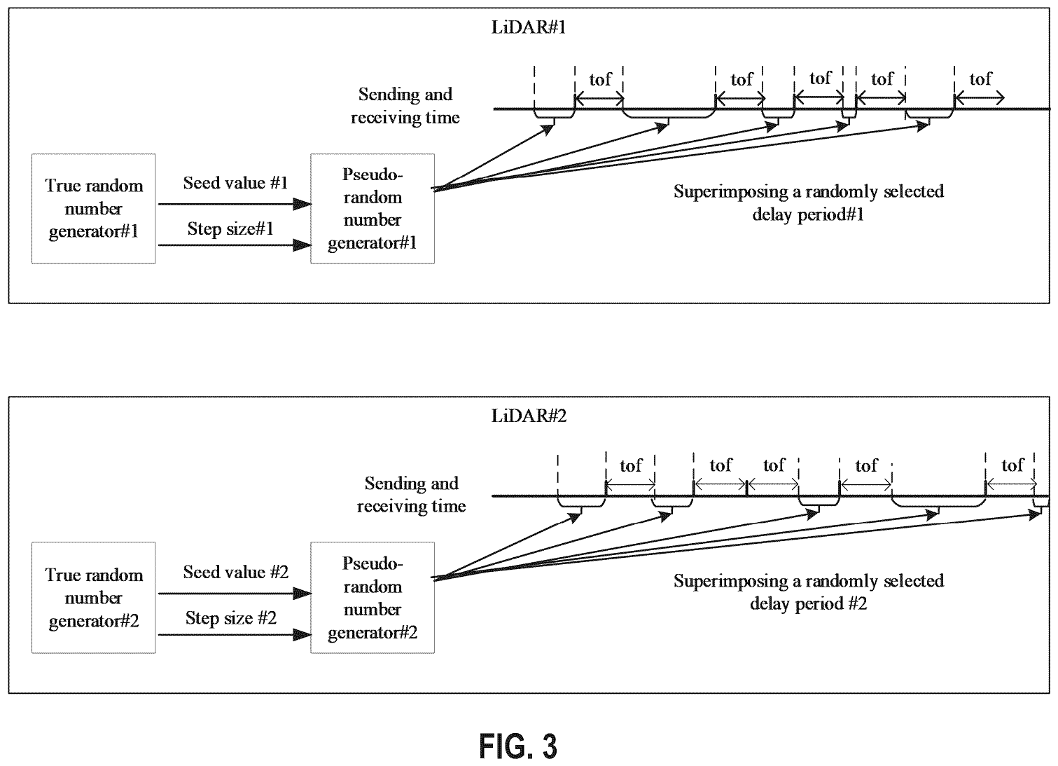

FIG. 3 shows an exemplary architecture of LiDAR #1 and LiDAR #2 provided by an embodiment. As shown in FIG. 3, LiDAR #1 includes a true random number generator #1 and a pseudo-random number generator #1, where the true random number generator #1 transmits seed value #1 and step size #1 to the pseudo-random number generator #1. LiDAR #2 has a similar structure. For example, the true random number generator #1 in LiDAR #1 generates seed value #1 and step size #1, while the true random number generator #2 in LiDAR #2 generates seed value #2 and step size #2, where seed value #1 is different from seed value #2, and/or step size #1 is different from step size #2. Therefore, the first delay period set #1 generated by the pseudo-random number generator #1 is less likely to be the same as the first delay period set #2 generated by the pseudo-random number generator #2. This enhances the anti-interference effect of the LiDAR, improving detection accuracy.

In combination with FIG. 3, by superimposing the selected delay period on the last received laser signal's receiving time, the emission time of this laser signal is obtained, which can be understood as superimposing a randomly selected delay period before each ToF's start time or after each ToF's end time, making the end time of each delay period the start time of the next ToF.

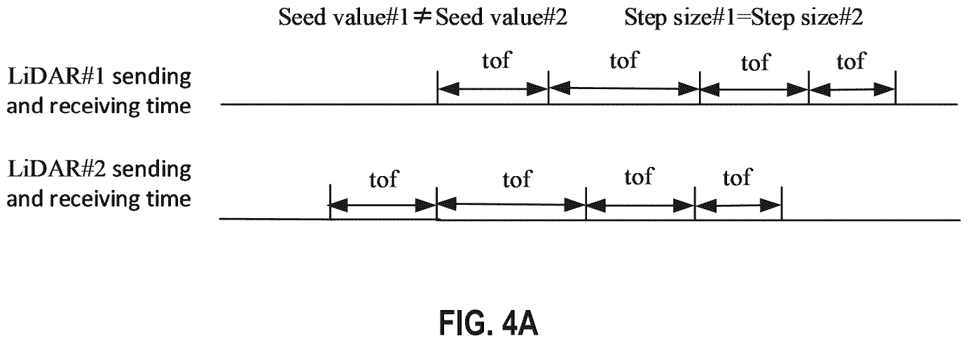

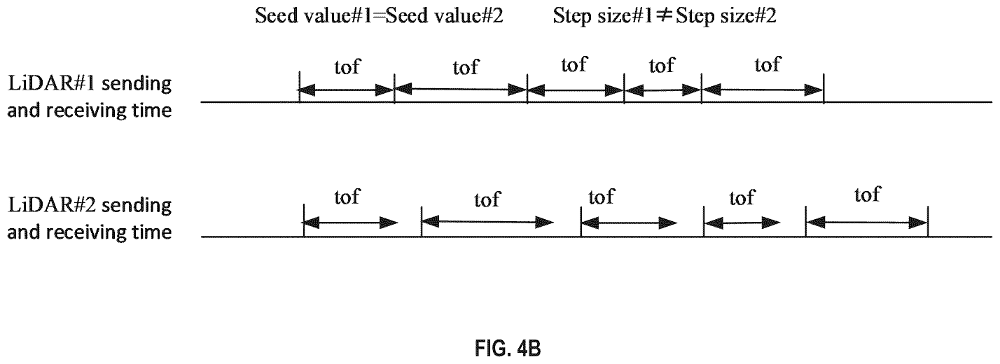

FIG. 4A shows an exemplary diagram of the sending and receiving times of LiDAR #1 and LiDAR #2 provided by an embodiment. As shown in FIG. 4A, seed value #1≠seed value #2, step size #1=step size #2, the duration of the i^{th} ToF of LiDAR #1 and the i^{th} ToF of LiDAR #2 are the same, but the sending time of the i^{th} ToF of LiDAR #1 and the receiving time of the i^{th} ToF of LiDAR #2 are different, where i≥1 and i is an integer.

FIG. 4B shows another example of the sending and receiving times of LiDAR #1 and LiDAR #2 provided by an embodiment. As shown in FIG. 4B, seed value #1=seed value #2, step size #1≠step size #2, the duration of the i^{th} ToF of LiDAR #1 and the i^{th} ToF of LiDAR #2 are different, but the sending time of the i^{th} ToF of LiDAR #1 and the receiving time of the i^{th} ToF of LiDAR #2 are the same, where i≥1 and i is an integer.

In some embodiments, other than the examples provided in FIGS. 4A and 4B, there could also be cases where seed value #1≠seed value #2 and step size #1≠step size #2.

In the above steps of method 100, how to reduce the interference between different LiDARs is introduced. The following describes how the first emitting unit increases the sampling rate of the receiving side by controlling the first emission time in step S102.

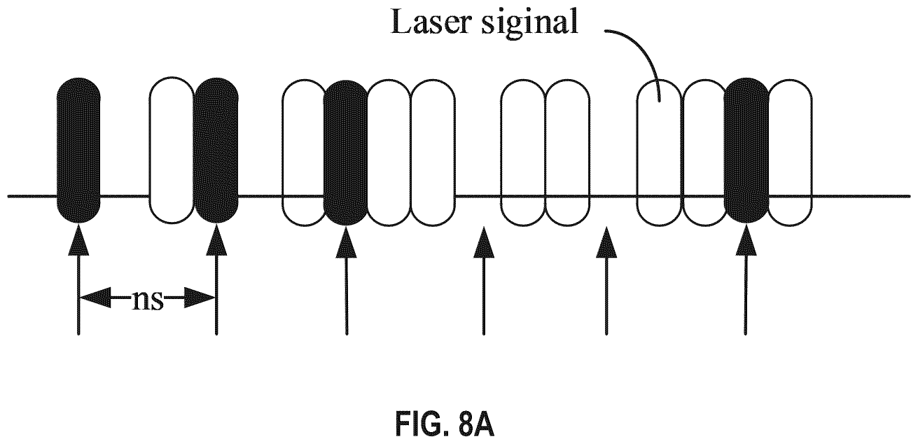

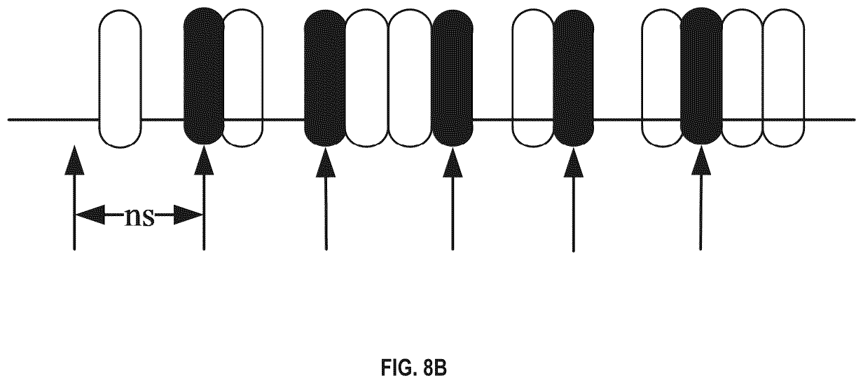

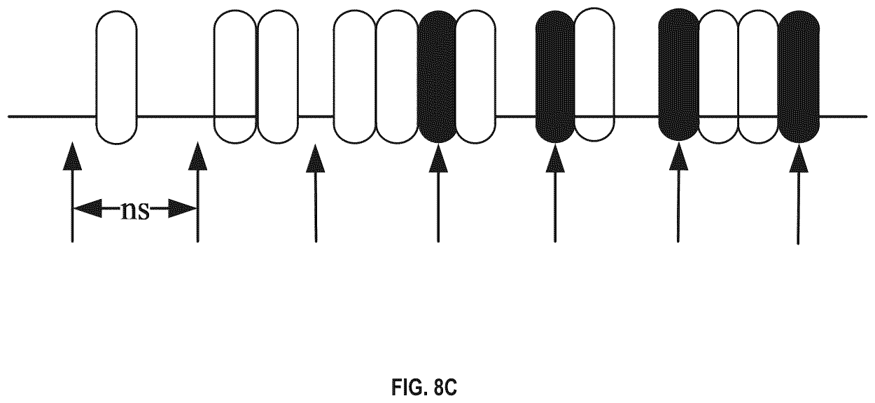

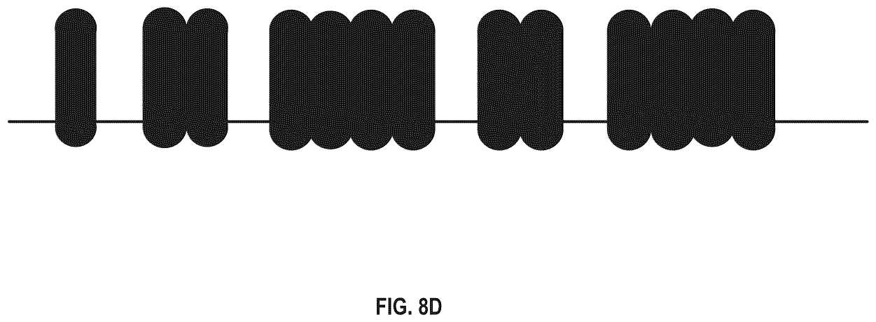

The sampling rate of the time-to-digital converter (TDC) on the receiving side is limited by digital working frequency and power consumption, and cannot be too large. The interval between two samplings is usually in the nanosecond range. This leads to photons received by the LiDAR within a certain period being missed, reducing the monitoring accuracy of the LiDAR. FIG. 8A shows the sampling situation without adding jitter provided by an embodiment. As shown in FIG. 8A, each arrow represents a sampling, and the interval between two arrows represents a sampling interval. The photon indicated by a black arrow is captured, while the photon indicated by a white arrow is missed. The arrows pointing to the blank area represent photons not captured. As shown in FIG. 8A, 9 photons are missed.

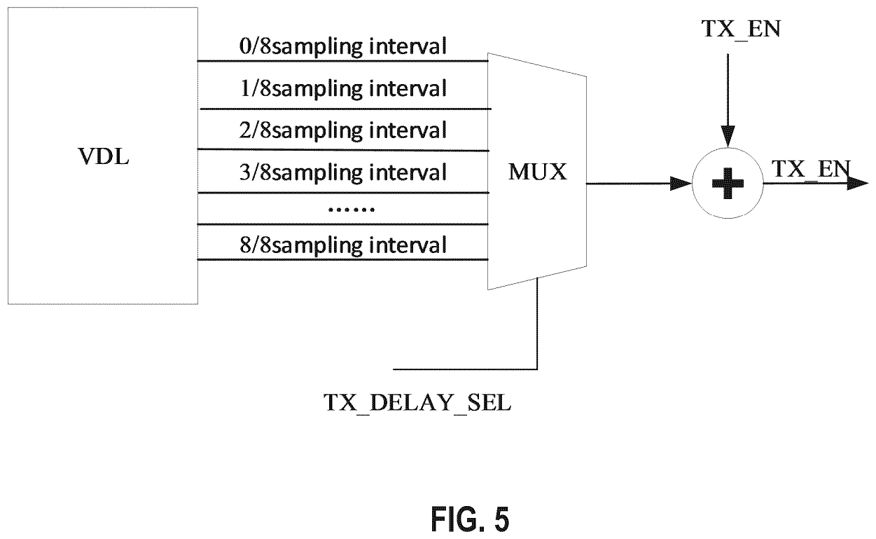

FIG. 5 shows an exemplary architecture of the first emitting unit provided by an embodiment. Exemplarily, the first emitting unit is a laser emitter. As shown in FIG. 5, the laser emitter includes a voltage-controlled delay line (VDL) and a multiplexer (MUX).

In an embodiment, the exemplary implementation of step S102 is introduced in combination with FIG. 5. The plurality of first emission times includes the z^{th} first emission time, where z≥1, and z is an integer.

Step 1, the VDL periodically generates X third delay sets.

The multiple third delay sets correspond one-to-one to the plurality of first emission times. Each time the first emitting unit emits a laser signal, the VDL generates a third delay set. The third delay set corresponding to the z^{th} first emission time is called the second delay set. The second delay set includes multiple delay periods with different durations. Exemplarily, the second delay set includes delay periods with durations of 0, ⅛ sampling interval, 2/8 sampling interval, . . . , 8/8 sampling interval.

Step 2, selecting a fifth delay period from the second delay set.

Exemplarily, a tx_delay_sel signal periodically generated by the digital circuit selects a fifth delay period from the second delay set.

Step 3, determining the z^{th} first emission time according to the random variable and the fifth delay period.

In an embodiment, the emission time of the z^{th} laser signal to be emitted determined according to the random variable is Tz, the fifth delay period is superimposed on the original tx_en to output TX_EN. The emission time corresponding to tx_en is Tz, and the emission time corresponding to TX_EN is the z^{th} first emission time.

In an embodiment, by adding non-fixed jitter (i.e., adding delay periods to the emission time), the first emission time is obtained.

FIGS. 8B, 8C, and 8D show the sampling situation after adding jitter for the first and second scans and their combination, respectively, provided by an embodiment. As shown in FIG. 8B, the first scan captures 5 more photons compared to without adding jitter. As shown in FIG. 8C, the second scan captures 4 more photons compared to without adding jitter. Combining the two cases with added jitter, as shown in FIG. 8D, all photons are captured after adding jitter.

It should be noted that the exemplary implementation of step S102 can be a separate method that includes:
Step 1′, the VDL periodically generates X third delay sets.
Step 2′, selecting a fifth delay period from the second delay set.
Step 3′, determining the z^{th} first emission time according to the fifth delay period.

The description of steps 1′ to 3′ can refer to the description of steps 1 to 3, with the difference being that in step 3′, the emission time of the z^{th} laser signal (Tz) is not necessarily determined according to the random variable, and thus the first emission time is not necessarily determined according to the random variable.

Next, method 200 is described to explain how to reduce interference within a LiDAR. When a LiDAR uses dual-scan mode, for example, a LiDAR includes left and right emitting arrays and a receiving array, if the left and right emitting channels emit simultaneously, mutual interference will occur between the left and right channels.

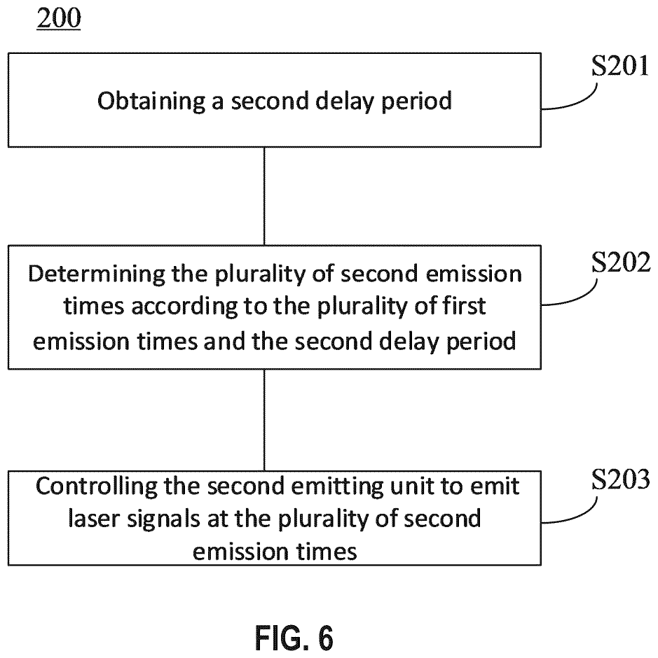

FIG. 6 shows a schematic diagram of the laser detection method 200 provided by an embodiment. This method 200 is applied to the aforementioned LiDAR with two emitting channels. The LiDAR includes a first emitting unit, a second emitting unit, a first register, and a second register. The description of the first emitting unit can refer to the corresponding part of method 100.

S201, obtaining a second delay period.

In an embodiment, the first emitting unit and the second emitting unit correspond to the left and right channels respectively. Without considering mutual interference between the left and right channels, the emission times of the left and right channels are the same. For example, the predetermined emission times for the first emitting unit and the second emitting unit are the third emission times. Suppose the initial emission time of the left and right channels is TO, which can be understood as the start time of the first third emission time. As an example, by configuring different delay periods for the initial emission times of the first emitting unit (the first first emission time) and the second emitting unit (the first second emission time) relative to TO through the first register and the second register respectively, the initial emission times of the first emitting unit and the second emitting unit will have relative delay periods, which are the second delay periods. Thus, each first emission time has a corresponding second emission time with the second delay period in between.

The exemplary implementation of S201 is given below. The difference between the third delay period and the fourth delay period is used as the second delay period. The first emission times correspond one-to-one to the third emission times, which are the predetermined emission times for the first and second emitting units. The third delay period is the delay period of a first emission time relative to the corresponding third emission time, and the fourth delay period is the delay period of a second emission time relative to the corresponding third emission time.

In an embodiment, combined with method 100, the second delay period is determined according to the random variable and the plurality of first emission times.

In an embodiment, the exemplary implementation of S201 includes: configuring the third delay period according to the first register; configuring the fourth delay period according to the second register.

In an embodiment, the names and descriptions of the first register and the second register are as shown in Table 1. The name of the first register is Csr_left_tdelay, which is used to configure the left channel emission time relative to the start point. The name of the second register is Csr_right_tdelay, which is used to configure the right channel emission time relative to the start point. The start point here is the aforementioned TO.

TABLE 1

| Name | Description |
|---|---|
| Csr_left_tdelay | Left channel emission time relative to the |
| | start point delay |
| Csr_right_tdelay | Right channel emission time relative to the |
| | start point delay |

S202, determining the plurality of second emission times according to the plurality of first emission times and the second delay period.

The plurality of first emission times correspond one-to-one to the plurality of second emission times.

The second delay period is the delay period of a second emission time relative to the corresponding first emission time in the plurality of first emission times.

S203, controlling the second emitting unit to emit laser signals at the plurality of second emission times.

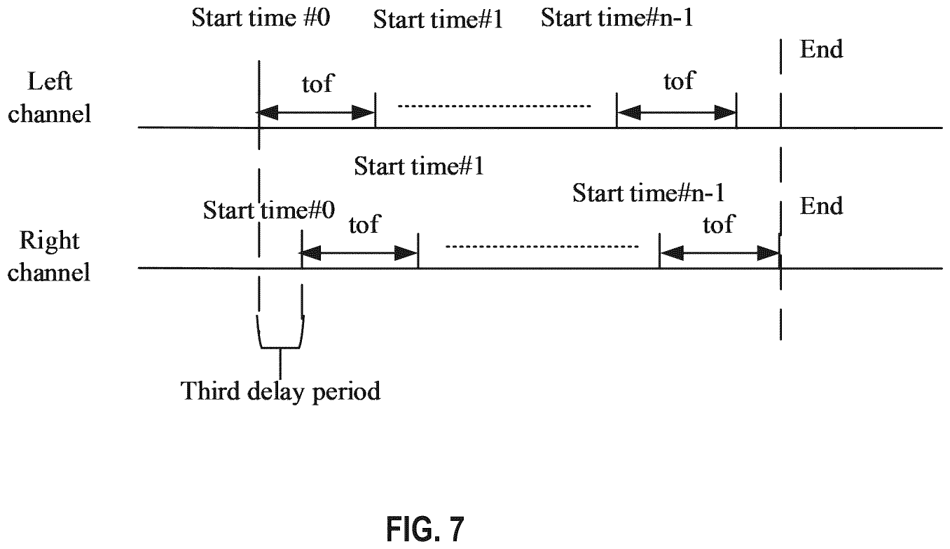

FIG. 7 shows an example of the sending and receiving times for the left and right channels during simultaneous scanning within the LiDAR provided by an embodiment. As shown in FIG. 7, the start time of each ToF can be understood as the emission time corresponding to that ToF. The relative time delay between the left channel start time #0 and the right channel start time #0 is the second delay period, . . . , the relative time delay between the left channel start time #n−1 and the right channel start time #n−1 is the second delay period.

Embodiments of this application improves the anti-interference effect between the left and right channels of the LiDAR by reducing the overlapping periods of the flight times of the left and right channels through the relative time delay between the left and right channels, improving detection accuracy.

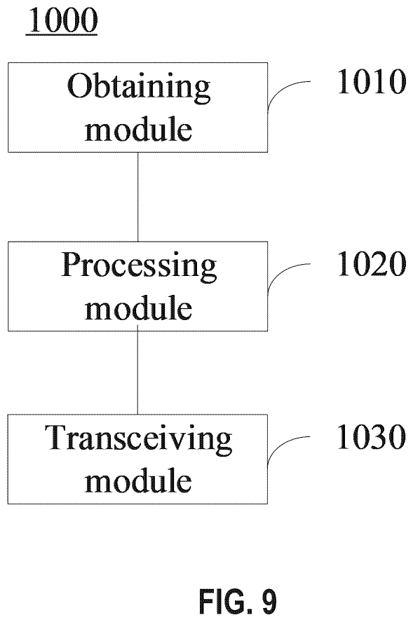

FIG. 9 shows a structural block diagram of the device 1000 provided by an embodiment of this application.

Referring to FIG. 9, the device includes the following modules:
an obtaining module 1010, configured to obtain a random variable; a processing module 1020, configured to determine a plurality of first emission times according to the random variable;
a transceiving module 1030, configured to emit laser signals at the plurality of first emission times by the first emitting unit.

The information interaction and execution processes between the above modules/units are based on the same concept as the method embodiments. The functions and technical effects can be referred to in the methods and system embodiments.

For convenience and simplicity of description, the division of the functional units or modules mentioned above is exemplary. In practical applications, the above functions can be assigned to different functional units or module, the internal structure of the device can be divided into different functional units or modules to complete all or part of the functions described above. The functional units or modules in the embodiments can be integrated into one processing unit, or can exist separately, or can be integrated into one unit. The integrated unit can be implemented in hardware or software. The names of the functional units or modules are just for convenience of mutual distinction. The working process of the units or modules in the system can refer to the corresponding process in the previous method embodiments.

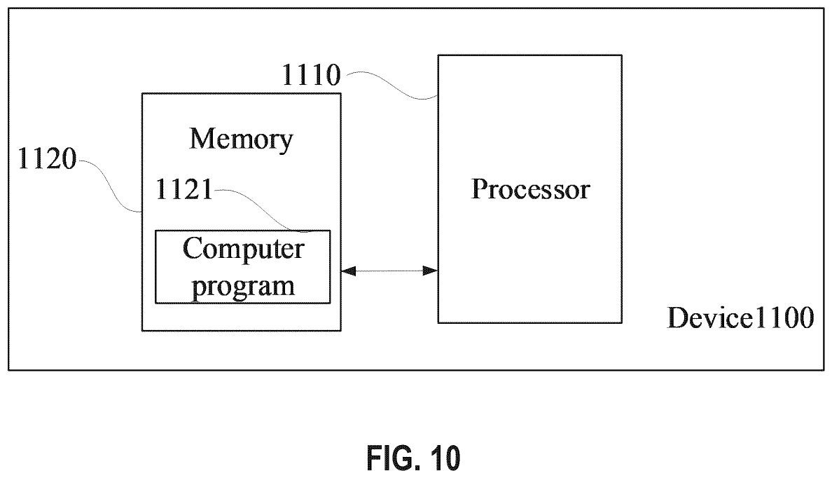

As shown in FIG. 10, an embodiment of this application provides a device 1100, including: at least one processor 1110, a memory 1120, and a computer program 1121 stored in the memory and executable on the at least one processor. When the processor executes the computer program, it implements the steps in any of the method embodiments described above.

Embodiments of this application provide a computer-readable storage medium. The computer-readable storage medium stores a computer program. When the computer program is executed by a processor, it implements the steps in any of the method embodiments described above.

Embodiments of this application provide a computer program product. When the computer program product is run on an electronic device, it enables the mobile terminal to execute the steps in any of the method embodiments described above.

If the integrated unit is implemented as a software functional unit and sold or used as an independent product, it can be stored in a computer-readable storage medium. All or part of the processes in the method embodiments described above can be completed by instructing related hardware through a computer program. The computer program can be stored in a computer-readable storage medium. When the computer program is executed by a processor, it can implement the steps in any of the method embodiments described above. The computer program includes computer program code that can be in the form of source code, object code, executable file, or some intermediate form. The computer-readable medium can include any entity or device capable of carrying computer program code, such as recording media, computer memory, read-only memory (ROM), random-access memory (RAM), electrical carrier signals, telecommunication signals, and software distribution media. For example, USB drives, mobile hard drives, magnetic disks, or optical disks. In some jurisdictions, based on legislation and patent practices, computer-readable media cannot be electrical carrier signals or telecommunication signals.

The functional units and algorithm steps described in various examples of this application can be implemented in electronic hardware, computer software, or a combination of both. Whether the function is executed in hardware or software depends on the specific application and design constraints of the technical solution.

In an embodiment, the disclosed devices/network equipment and methods can be implemented in other ways. For example, the device/network equipment embodiments described above are merely illustrative. For example, the modules or units described can be logically divided, and in practical implementations, the division can be different. Multiple units or components can be combined or integrated into another system, or some features can be ignored or not executed. Moreover, the coupling or direct coupling or communication connection between units or modules can be indirect coupling or communication connection through some interfaces, devices, or units, and can be in electrical, mechanical, or other forms.

The units described as separate components can be physically separated, or can be physical units. The components displayed as units can be combined into one unit or can exist as separate units. The integrated unit can be implemented in hardware or software. In practical applications, part or all of the units can be selected to achieve the objectives of this embodiment.

What is claimed is:

1. A laser detection method, applied to a LiDAR, wherein the LiDAR comprises a first emitting unit, and the method comprising:
obtaining a random variable;
determining a plurality of first emission times according to the random variable; and
controlling the first emitting unit to emit a laser signal at the plurality of first emission times.

2. The method according to claim 1, wherein the LiDAR further comprises a pseudo-random number generator, the random variable comprises a seed value and a step size, and
the determining the plurality of first emission times according to the random variable comprises:
generating a first delay period set by the pseudo-random number generator according to the seed value and the step size, wherein the first delay period set comprises a plurality of delay periods; and
determining the first emission times corresponding to the laser signal according to the plurality of delay periods.

3. The method according to claim 2, wherein the plurality of first emission times comprise X first emission times, the X first emission times correspond one-to-one to X first receiving times, the X first emission times comprise an i^{th} first emission time and an i^{th}+1 first emission time, the i^{th} first receiving time in the X first receiving times corresponds to the i^{th} first emission time, 0≤i≤X, and i and X are both integers; and
the determining the first emission time corresponding to the laser signal according to the plurality of delay periods comprises:
selecting a first delay period in the plurality of delay periods, as a delay period of the i^{th}+1 first emission time relative to the i^{th} first receiving time; and
determining the i^{th}+1 first emission time according to the i^{th} first receiving time and the first delay period.

4. The method according to claim 2, wherein the LiDAR further comprises a true random number generator, and the true random number generator is cascaded with the pseudo-random number generator, and
the obtaining a random variable comprises:
obtaining the random variable according to the true random number generator.

5. The method according to claim 1, wherein the LiDAR further comprises a second emitting unit, and the method further comprises:
obtaining a second delay period;
determining a plurality of second emission times according to the plurality of first emission times and the second delay period, the plurality of first emission times correspond one-to-one to the plurality of second emission times, and the second delay period is a delay period of a corresponding one of the plurality of second emission times relative to a corresponding one of the plurality of first emission times; and
controlling the second emitting unit to emit a laser signal at the plurality of second emission times.

6. The method according to claim 5, wherein the obtaining a second delay period comprises:
using a difference between a third delay period and a fourth delay period as the second delay period; and
the plurality of first emission times correspond one-to-one to a plurality of third emission times, the plurality of first emission times correspond one-to-one to the plurality of third emission times, the third emission time is a preset emission time for the first emitting unit and the second emitting unit, the third delay period is a delay period of a corresponding one of the plurality of first emission times relative to a corresponding one of the plurality of third emission times, and the fourth delay period is a delay period of a corresponding one of the plurality of second emission times relative to a corresponding one of the plurality of third emission times.

7. The method according to claim 6, wherein the LiDAR further comprises a first register and a second register, and the method further comprises:
configuring the third delay period according to the first register; and
configuring the fourth delay period according to the second register.

8. The method according to claim 1, wherein the plurality of first emission times comprise a z^{th} first emission time, z is greater than or equal to one, z is an integer, and
the determining the plurality of first emission times according to the random variable comprises:
selecting a fifth delay period in a second delay set, the second delay set comprises a plurality of delay periods with different durations; and
determining the z^{th} first emission time according to the random variable and the fifth delay period.

9. The method according to claim 8, wherein the first emitting unit comprises a voltage-controlled delay chain, and the method further comprises:
periodically generating a plurality of third delay sets by the voltage-controlled delay chain, the plurality of third delay sets correspond one-to-one to the plurality of first emission times, and the second delay set is a set in the plurality of third delay sets corresponding to the z^{th} first emission time.

10. A laser detection device, comprising a storage, a processor, and computer program stored in the storage and executable on the processor, wherein the computer program, when executed by the processor, cause the processor to perform operations comprising:
obtaining a random variable;
determining a plurality of first emission times according to the random variable; and
controlling the first emitting unit to emit a laser signal at the plurality of first emission times.

11. A non-transitory computer-readable storage medium storing a computer program, wherein the computer program, when executed by a processor, causes the processor to perform operations comprising:
obtaining a random variable;
determining a plurality of first emission times according to the random variable; and
controlling the first emitting unit to emit a laser signal at the plurality of first emission times.
